(19) United States
(12) Patent Application Publication
(10) Pub. No.: US 2009/0124354 A1
(43) Pub. Date: May 14, 2009

(54) METHOD FOR ATTRIBUTING GAMEPLAY CREDIT TO A PLAYER

(75) Inventor: John F. Acres, Corvallis, OR (US)

Correspondence Address: MARGER JOHNSON & MCCOLLOM, P.C., 210 SW MORRISON STREET, SUITE 400, PORTLAND, OR, 97204, US

(73) Assignee: Acres-Fiore, Inc., Las Vegas, NV (US)

(21) Appl. No.: 12/061,516

(22) Filed: Apr. 2, 2008

Related U.S. Application Data
(60) Provisional application No. 60/987,293, filed on Nov. 12, 2007.

(51) Int. Cl. G06F 17/00

(52) U.S. Cl. 463/25

(57) ABSTRACT

Embodiments of the present invention are directed to properly and accurately attributing gameplay to a player. Identification of a player can be associated with the gameplay either before gameplay begins, during the gameplay itself, or after the gameplay ends. Some embodiments use various gathered data and metrics to accurately determine the proper player to attribute.

### RELATED APPLICATIONS

This application claims priority to U.S. Provisional Patent application No. 60/987,293, filed Nov. 12, 2007, entitled USING A PLAYER TRACKING SYSTEM TO IMPLEMENT A BONUS AWARD FOR A PLAYER OF AN ELECTRONIC GAMING MACHINE, the contents of which are hereby incorporated by reference. Additionally, this application is related to U.S. non-provisional application No. ______, (Attorney Docket No. 1351-______) filed on even date herewith, entitled SYSTEM FOR ATTRIBUTING GAMEPLAY CREDIT TO A PLAYER, the teachings of which are hereby incorporated by reference.

### TECHNICAL FIELD

The present invention relates to reward systems, and, more particularly, to methods for attributing gameplay activity credit to a player.

### BACKGROUND

Player tracking systems allow game owners, for example, casinos, to gather data about players using their systems. A casino incentivizes players to use such player tracking systems by providing extra benefits to the players, such as larger or more frequent payouts than the base game otherwise pays, or additional benefits such as complementary play, special triggers or features available only to identified players, free or discounted tickets to events, entry to special events, or free/reduced price items such as food and products, among others.

Typical player tracking systems use a player identification card, such as a magnetic swipe card to identify the player. Before gameplay the player inserts his/her card in the player tracking system, and removes it after the gameplay has concluded. Gameplay between the time the card is inserted and removed is credited to the player in the player tracking system.

Problems arise because many players forget to retrieve their cards from the player tracking system after they are finished playing the game. Typically, casino employees will remove the cards from games that are not being played. In some instances, later players will remove a card that was present in the tracking system at a vacant machine to insert their own card so that the new player receives credit for his/her gameplay. The new player may place the former player's card on top of the machine, give it to a casino employee, or simply throw the card away.

Reissuing cards to players that left them in the player tracking system is expensive and time consuming for the casinos, as well as frustrating for the players.

Embodiments of the invention address this and other problems in the prior art.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, and 2C are detail diagrams of exemplary types of gaming device according to embodiments of the present invention.

FIG. 3 is a functional block diagram of networked gaming devices according to embodiments of the present invention.

FIGS. 4A, 4B, 4C, and 4D are timeline diagrams illustrating operation of embodiments of the invention.

FIG. 5 is a functional block diagram of a gaming network coupled to various accounts according to embodiments of the invention.

FIGS. 6A, 6B, and 6C are example screen diagrams illustrating communication between a casino and a player.

### SUMMARY

Although players frequently leave their player tracking cards in a game, they almost never leave a game that has credits on the meter; players either spend all the credits or cash out the credits. Embodiments of the invention use this human behavior to help attribute gameplay to the proper player.

In one embodiment, game activity is credited to a player if he/she was identified at any time between the time game machine credit is established on the game and when the credit reaches zero. In other words, if a player is identified at any time during a gaming session, all the gameplay credit for that session is attributed to the identified player. In other embodiments, gameplay credit that accumulated during a time period when no player was identified as the generator of the gameplay is credited to a later-identified player.

### DETAILED DESCRIPTION

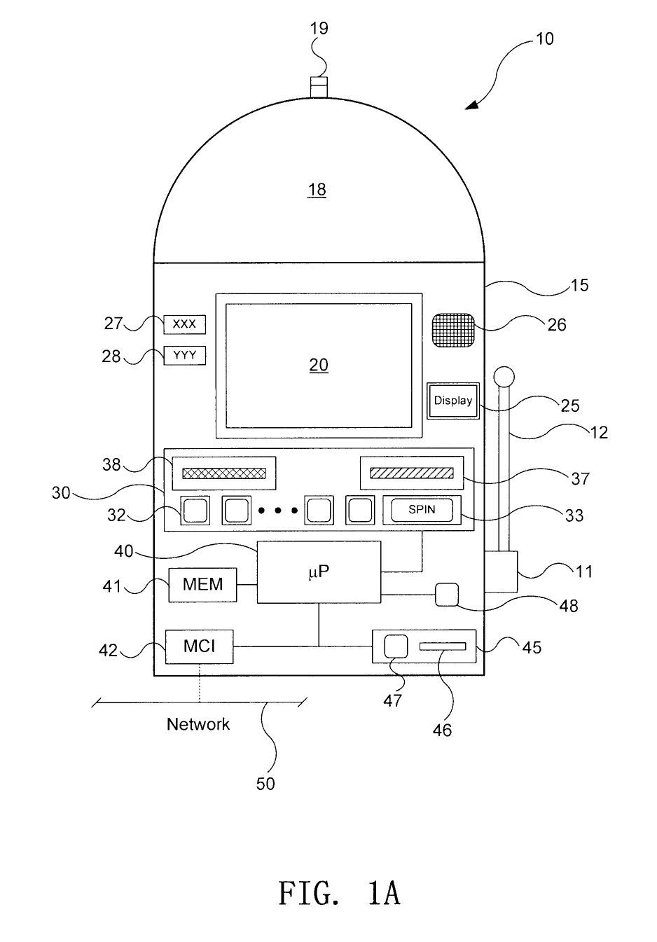

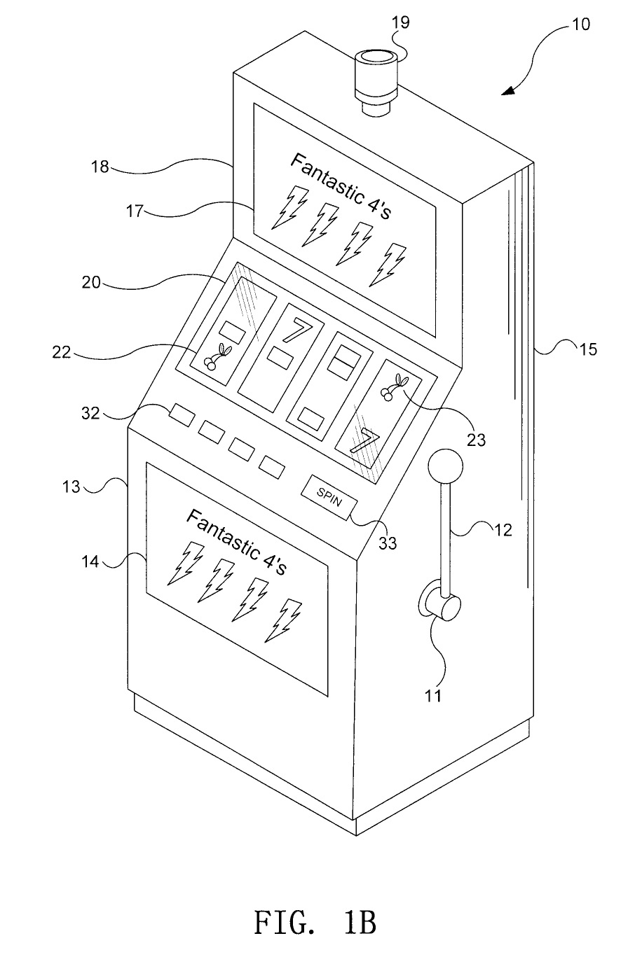

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electromechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, and other similar devices. Although embodiments of the invention will work with all of the gaming types mentioned, for ease of illustration the present embodiments will be described in reference to the electronic gaming machine 10 shown in FIGS. 1A and 1B.

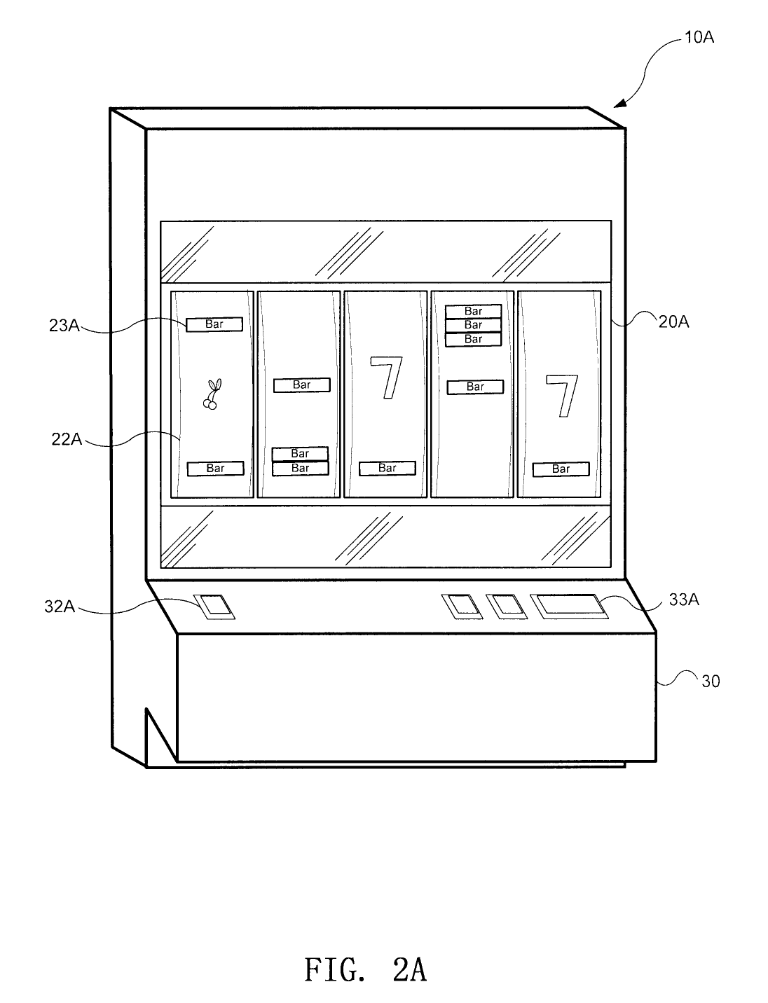

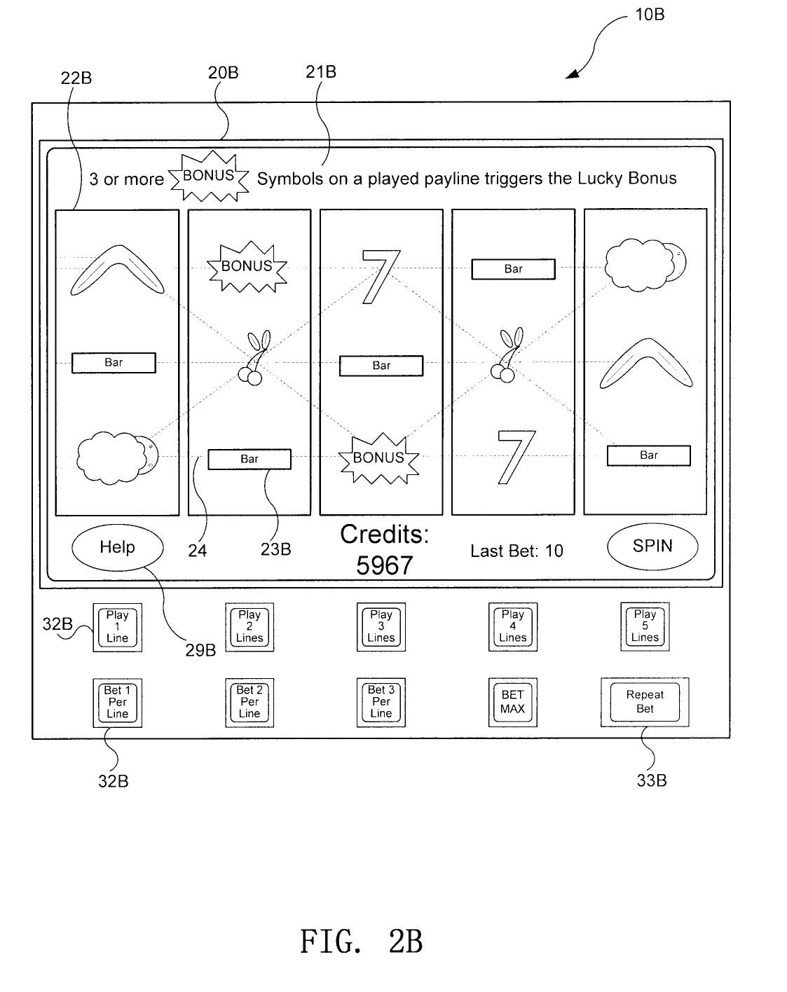

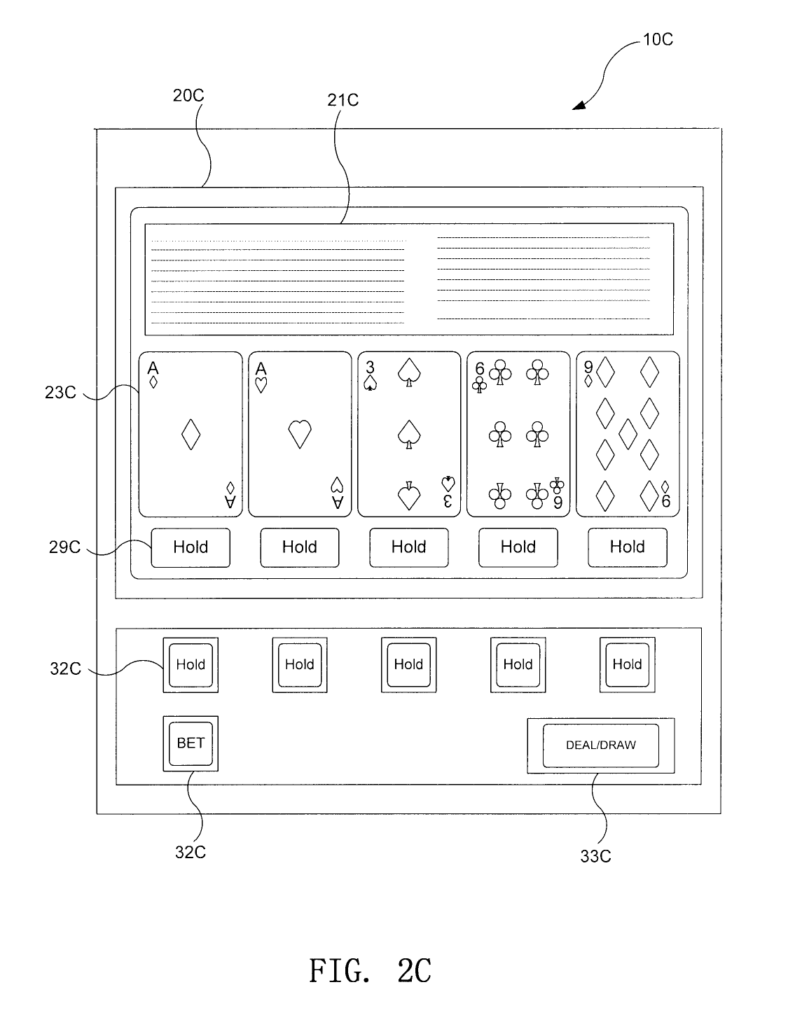

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show ancillary information to the player. For example, the secondary display 25 may show player tracking information, secondary bonus information, advertisements, or player selectable game options.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicate with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

The player tracking unit 45 may include an identification device 46 and one or more buttons 47 associated with the player tracking unit 45. The identification device 46 serves to identify a player, by, for example, reading a player-tracking device, such as a player tracking card 66 that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit card into a card reader/authorizer (not shown). The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that arc applied to the credit meter 27.

FIGS. 2A to 2C illustrate exemplary types of gaming devices according to embodiments of the invention. FIG. 2A illustrates an example spinning-reel gaming machine 10A. FIG. 2B illustrates an example video slot machine 10B, and FIG. 2C illustrates an example video poker machine 10C.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23A appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines various other types of gaming devices known in the art are contemplated and are within the scope of the invention.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote gaming server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, firewire lines, USB lines, or other communication protocols. Although not shown in FIG. 3, substantially the entire network 50 may be made of optical lines 64 or may be a wireless network.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records on in the player database 90 to provide the player with information regarding their player accounts or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

As described above, one way to track data about various players is to identify a player prior to a gaming session, and attribute gameplay during the session to that player. To identify a player, the player inserts his or her player identification card into the identification device 46 of FIG. 1A and begins playing. Gameplay is attributed to the player (i.e., stored in the database 90 of FIG. 3) as he or she plays. After the player has finished playing, the player removes the card from the gaming device 10.

There is a problem, however, in players forgetting to take their cards after they have finished playing. Later players may remove these cards (so that they may insert their own cards) and throw the removed card away. Casino employees may also remove cards from unattended games and store them to be returned to the proper player. Re-issuing lost cards to players is time consuming and frustrating. Embodiments of the invention capitalize on the fact that players almost never leave a game when there are credits still on the meter. Instead, a player will naturally play until all of the credits are either wagered or until the player cashes out. Therefore, embodiments of the invention, differently than as described above, attribute gameplay to a player if they are identified any time between when credits are established on the machine to when the credits are removed, either by gameplay or cashout.

Game machine credit can be established in a number of ways, as is known. Modem gaming machines are all equipped with currency or bill acceptors 37, through which players can register a relatively large number of gambling credits at once. For example, insertion of a $100 bill in a quarter machine provides 400 credits.

If the player identity is registered when credits are deposited, or while credits remain on the game, it is safe to presume the player's identity remains the same until that credit balance drops to zero. By this method, a player who inserts his/her identification instrument at the time of credit deposit, or while a positive credit balance is on the machine, then immediately removes the identification instrument and puts it in a safe place such as their pocket gets credit for the entire session, even though the card was removed before the end of the session. In other words, for so long as the credit balance remains positive, the identified player is presumed to be the player by the player tracking system and for purposes of accomplishing triggers and receiving and utilizing bonus awards.

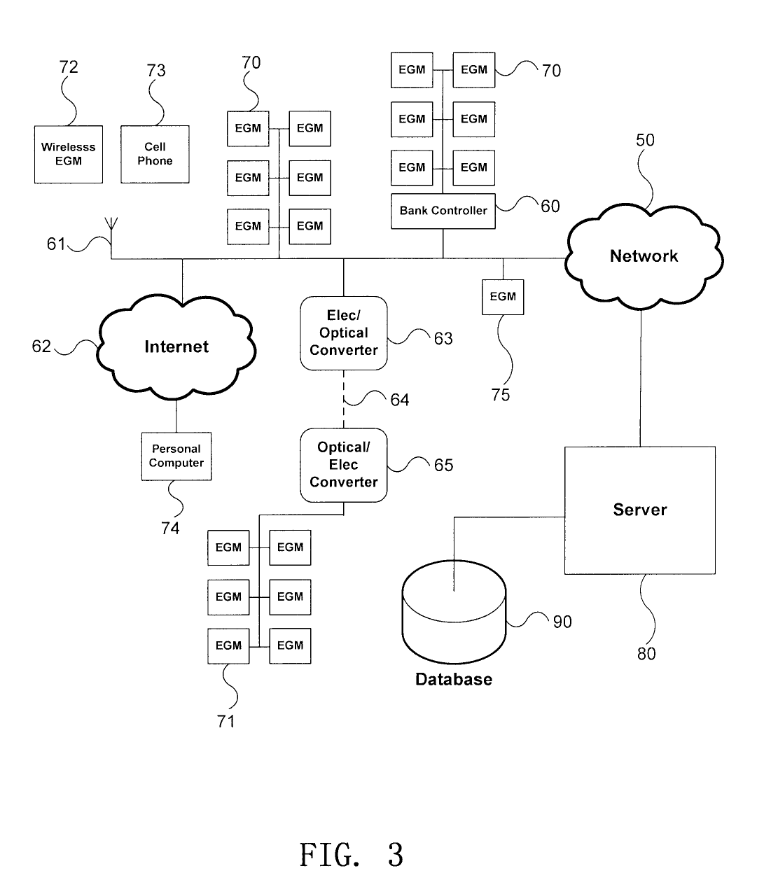

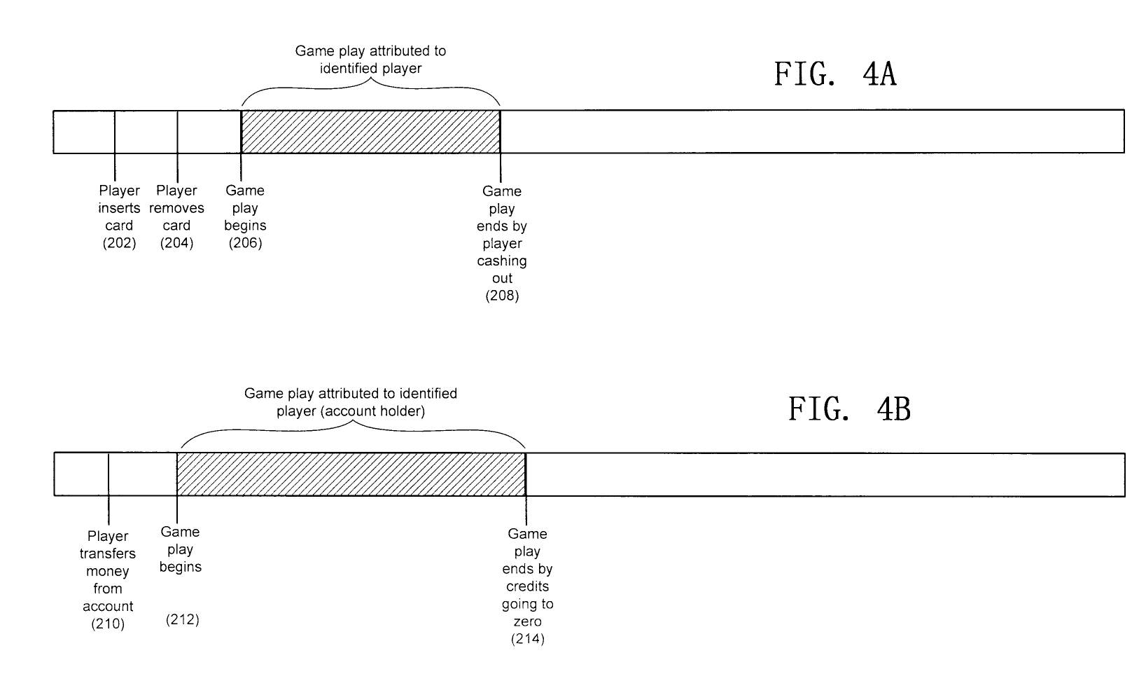

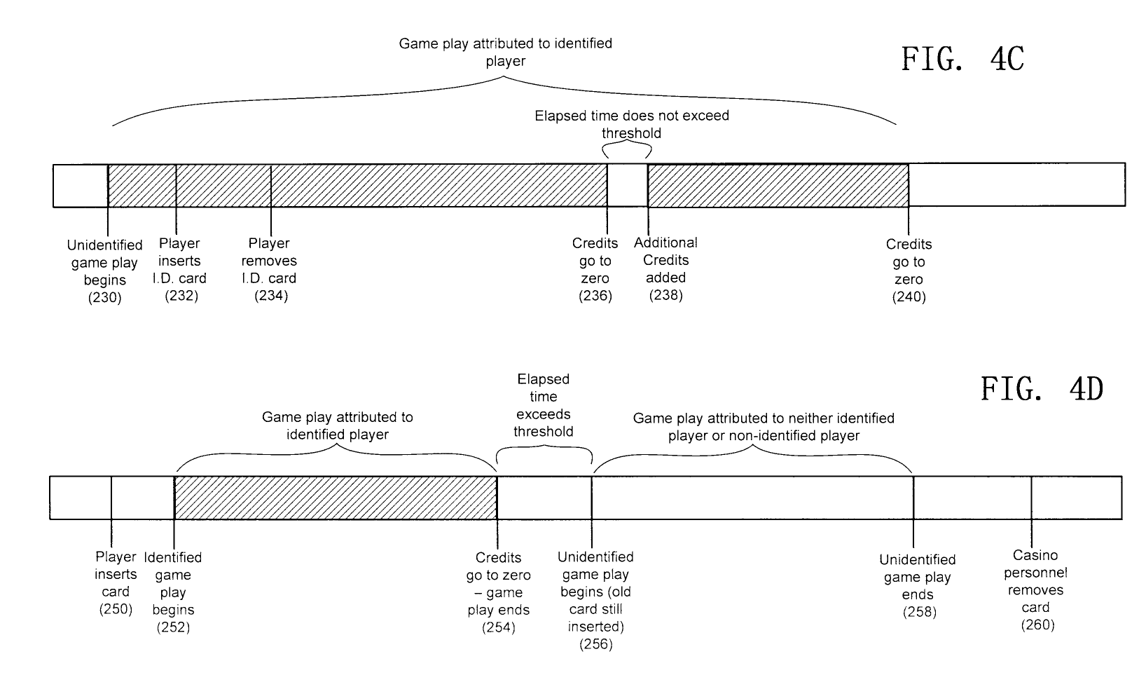

Such an embodiment is illustrated in FIG. 4A, which illustrates a timeline and various actions of the player at a gaming device 10. In that figure, a player inserts an identification card at a time 202 and establishes an identity with the gaming device 10 and/or the server 80 through the network 50 of FIG. 3. At a time 204 the player removes the card. Gameplay begins at time 206, which means credit has been established on the gaming device 10 and the player is actively playing the game on the gaming device. At a time 208 the player cashes out, which simultaneously ends gameplay. Embodiments of the invention credit all of the gameplay time, that is the gameplay between times 206 and 208 to the identified player, even though the player had already removed the player identification card at the time 204.

In another embodiment, if the player tracking system detects gameplay at gaming device 10 with an unidentified player (for instance no player card is inserted), the system can, for example over the gaming network 50, display an invitation message on the display 20 (FIG. 2). In one example, the message may inform the unidentified player that she could receive substantial benefit for signing up for a player account. It may be that the player accidentally forgot to insert her card, in which case inserting the card would attribute the appropriate gameplay to her player account. In other scenarios, the gaming device 10 may display a coded message or invite the player to print a printed invitation through the ticket printer 38. The code or printed invitation can identify the gaming session such that, when the player signs up for a player account by presenting the code or invitation to the casino, the proper gameplay can be attributed to the player, even though the gameplay has already completed. In another embodiment, the invitation message may include a facility for accepting player identification information such that the player could sign up for an account through the gaming device 10 itself.

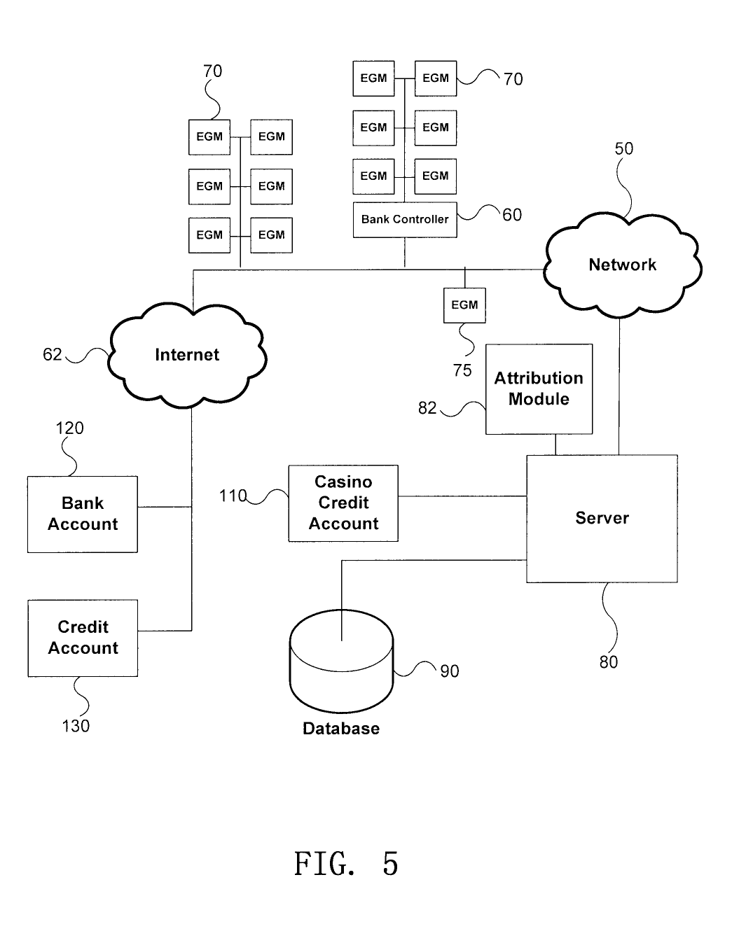

Game machine credit may also be established by transferring value to the game, such as by transfers from a casino credit account, a bank account, cashout tickets, or other account sources. Embodiments of the invention use identity information associated with the account as player identification information. For instance, with reference to FIG. 5, if “Player A” transfers value from her casino credit account 110 to a game 70 over the network 50, embodiments of the invention automatically attribute gameplay during the session started by that transfer to Player A. Thus, the gameplay credit is added to Player A's account on the database 90. This occurs automatically without any extra input from Player A. Similarly, if the transfer is from a bank account 120, for example over the internet 62, and the account holder also has a player account, the account holder is credited with the gameplay for that session. Cashout tickets may include player identification information, and, if so, a session started by the insertion of a cashout ticket is associated with the correct player.

Such embodiments are illustrated in FIG. 4B. At a time 210, the player transfers credits to a gaming device 10 from a casino credit account 110, bank account 120, or other credit account 130 (FIG. 5). The account information is indexed against player accounts stored in the database 90 (FIG. 3) to correctly identify the player. Gameplay begins at time 212 and ends at time 214 by the credits going to zero. Credit for the gameplay between the times 212 and 214 is automatically credited to the correct player account, even though the player never entered a player card into the gaming device 10.

This technique allows the use of new identification instruments, such as an RFID device, which could be worn as a ring or embedded in a card or other device. So long as the identifier is in close enough proximity to be read at least once, for example by the identification device 46 (FIG. 1A), when an appropriate credit balance is held on the gaming machine, the identified person is presumed to be the player. For example, a player could wear a ring, watch or bracelet with an embedded RFID device. With appropriate RFID readers as the identification device 46, the identifier could be read without the player having to actually insert the identifier into any sort of reader.

In embodiments of the invention such as the ones described above, an identification transaction may have a much shorter duration than a duration of the gameplay session. In other words, a player need only be identified at some time during the duration of gameplay to be identified for the entire session. In some identification procedures, such as the RFID example above, the player may be asked to verify his or her identity in some way, such as by entering a PIN or other identifier to receive bonuses, awards, points, etc.

Many automobiles today utilize keyless ignition systems in which an electronic key is simply carried in a pocket. So long as the device is in proximity to the car, the automobile can be started. The same technology can be used with gaming machines or purposes of player tracking. One of skill in the art recognizes there are many types of identifiers, including standard magnetic stripe cards which can be used to advantage.

Other identification instruments include a keypad entry, for example an identification and/or a PIN number. Still other identification data could be used, for example, by having a player swipe a credit card or debit card, which store name identification on a magnetic strip, even if no value is transferred from the card accounts to the machine. Further, a video display may ask a player to enter contact or non-contact information, such as a unique email address, or a room number where the player is staying in the hotel casino. Still further, a player may be requested to swipe a room card, which can be associated with a casino hotel records to determine a player's identity.

Other embodiments could employ a proximity sensor 48 installed on the player tracking system 45, or in or around the game, to determine the physical presence of a player. Similar to the system described above, if the proximity sensor 48 senses a player at a gaming device 10, all gameplay during the time the sensor recognizes that the player is at the game will be attributed to the player. This can be used in conjunction with or separate to the positive credit method of determining a gaming session.

The end of a gameplay session need not necessarily occur exactly when the game credits reach zero. First, the gameplay session could be determined to end when the game credits are between zero and the lowest denomination of the gaming device 10. For instance, by transferring in credits from a previously cashed-out ticket, a player may transfer an uneven amount. For example, assume that a player was playing at a penny game and cashed out $4.17. Then the player moved to a quarter denominated game, and used the ticket to establish credits. Then the player used all the possible credits, but $0.17 still appears on the credit meter 27 of the gaming device 10. Because there is not enough value on the gaming device 10 for another credit (which would cost $0.25), the player may simply walk away leaving credit on the credit meter 27. Embodiments of the invention can determine that the gameplay has ended in such a situation, even though credits still appear on the credit meter 27, because the value on the credit meter does not exceed the minimum denomination threshold for the gaming device 10.

In other embodiments, the player can be allowed to drop all the way to a zero credit balance on the gaming machine for a time period, for example “x” seconds, before she is presumed to have left the machine. For example, a player inserts a $20 bill into a gaming machine and is appropriately identified. The player spends all $20 in the game and the game reaches a zero balance. The player opens her pocketbook, removes another $20 and inserts that into the game. So long as the new credits are deposited within the defined time limit, for example, 120 seconds, the identity of the player of the current (second) session is presumed to be the same as the identity of the player of the previous (first) session.

Such an embodiment is illustrated in FIG. 4C. In that scenario, a player begins unidentified gameplay at a time 230. Between the times 232 and 234, a player is identified by the gaming device, such as by the player inserting a player card or through another method such as RFID identification described above. At a time 236, the credits go to zero, but the player is still interested in playing the gaming device 10. At a time 238, additional credits are added to the gaming device 10, such as by adding more currency to the bill acceptor 37 of FIG. 1. The time period between times 236 and 238 does not exceed the threshold time for a player identification reset, such as 120 seconds. In other words, in the example shown in FIG. 4C, the time period between times 236 and 238 is less than 120 seconds. At time 240 the credits go to zero and the player walks away from the game. In the embodiment illustrated in FIG. 4C, all of the gameplay credit between times 230 and 240 is credited to the player, even though no player was identified at time 230, when gameplay began, and there was a period of time, between times 236 and 238, where there were no credits on the game meter 27 (FIG. 1).

Another embodiment is illustrated in FIG. 4D, which highlights the automatic time expiration. In that Figure, a player inserts a player ID card at a time 250 and plays the game between times 252 and 254. The player then walks away from the gaming device 10 but forgets to remove his or her player ID card. At a time 256 a new player begins playing the gaming device 10 with the old players ID card still inserted into the gaming device. At time 258 the second player walks away from the machine when the credits go to zero. Some time later, at a time 260, a casino employee notices that there is a player ID card in a vacant gaming device 10, and removes the card. Embodiments of the invention correctly determine that the gameplay between times 252 and 254 should be attributed to the first player. However, because the time period between times 254 and 256 exceeded the time threshold, i.e., the gameplay between times 256 and 258 should not, and indeed, is not, attributed to the first player.

In further embodiments, the second player in the example of FIG. 4D could notice, sometime during the gameplay 256 and 258 that another player's ID card is in the gaming device 10. By calling over a casino employee, gameplay for the second player, that is gameplay between the times 256 and 258 could be properly attributed to the second player, either by establishing a new player account for the second player, or by associating the gameplay that began at time 256 to the second players existing player account. Still further, if the second player already has a player account, the act of removing the forgotten card and inserting his or her own card will cause the second player to receive the proper gameplay attribution, without casino personnel involvement. For instance, with reference to FIG. 4D, if the second player removes the forgotten card and inserts his or her own at a time between 256 and 258, then the gameplay between times 256 and 258 is attributed to the second player.

The accuracy of such a system can be enhanced by using additional information from the proximity sensor 48. Thus, if the proximity sensor data indicated that a person was continuously at the gaming device 10 during the time the credits were zero, the subsequent session would be automatically attributed to the original player. If the proximity sensor data indicated that the first player walked away from the machine, the new session would not be attributed to the first player, even if a new player inserted credits into the machine during the 120 second interval. Similarly, if a new player identification was determined during the waiting period, such as a new player card being inserted into the game, the new session would, of course, be attributed to the new player and not the old player.

Likewise, identifying a player need not necessarily occur during the time credits are on the machine, but a player may be identified prior to credits being deposited. For example, if a player enters and removes his player tracking card, then, after a short period of time, puts credits on the game meter, the session that began with those credits are attributed to the player who inserted and removed his card. The accuracy of this system, too, can be enhanced by using proximity sensor data as described above.

In some embodiments, an audio or visual display can let the player know that they have been properly identified by the player tracking system for the current gameplay session, and if their session has expired.

With reference back to FIG. 5, an example attribution system 82 is illustrated that operates in the player tracking system in conjunction with the remote server 80 and database 90. As described above with reference to FIG. 3, the remote server 80 and database 90 may form all or a portion of a player tracking system. The player attribution system 82 is coupled to the remote server 80 and implements the player attribution functions of the player tracking system as described above and below. Although FIG. 5 illustrates the player attribution system 82 as being attached to the remote server 80, the attribution system 82 may actually be a part of the remote server 80 itself. In this sense, the attribution system 82 may be separate hardware and/or software installed with the remote server 80, or hardware and/or software coupled to the remote server. The attribution system 82 may be implemented as a part of the remote server 80 itself, with no clear delineation of resources specifically allocated to the attribution system 82 that are separate from the remote server. Alternatively, although not illustrated in FIG. 5, the attribution system 82 may be directly attached to the database 90 instead of the server 80, and may communicate to the remote server 80 only through the database 90, instead of having direct communication.

In operation, the attribution system 82 detects or receives signals and/or data from gaming devices 10 over the gaming network 50. It can also generate and send data and/or signals to the gaming devices 10. It additionally can retrieve or store information into the database 90, either directly or through the remote server 80. The attribution system 82 may store data from the gaming device 10 on the database 90 both before and after the player identity is known. In other words, the attribution system 82 may store all of the gameplay data from a particular gaming device 10, even when the player is not identified. Later, when the player is identified, the attribution system “credits” the appropriate player account by writing the appropriate data in the database 90 or through the remote server 80.

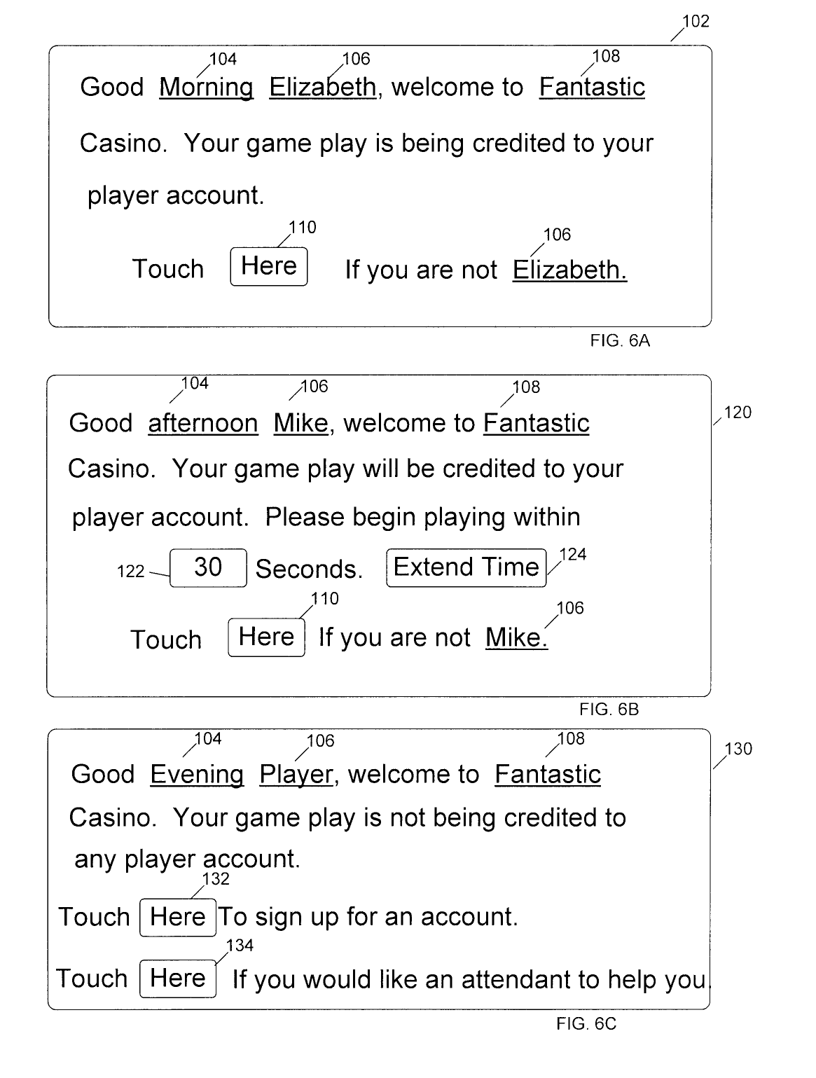

The attribution system 82 additionally includes various timers and other subsystems for determining when to attribute gameplay to various identified players. It further includes facilities for generating scripts to be displayed to a player of the gaming device 10. Such scripts can be generated for each player, or could be standard scripts with or without customization. Example scripts are described with reference to FIGS. 6A, 6B, and 6C below.

FIGS. 6A, 6B, and 6C illustrate some example scripted scenarios that help explain how the casino can communicate to the player that the gameplay is being attributed to the proper account. With reference to FIG. 6A, an example display screen 102 is illustrated. The display screens of FIGS. 6A, 6B, and 6C may be displayed anywhere on the gaming device 10 (FIG. 1) to communicate with the player, for example on the gaming display 20, player identification portion 21 of the gaming display (FIGS. 2B, 2C), or on the player tracking unit 45. The display screen 102 of FIG. 6A shows a message to the player that they have been identified to the gaming device 10 and the gameplay is being attributed to the proper account. For example, a field 106 indicates a name of the player, which has been retrieved from the database 90 of the playing tracking system when the player inserted his or her card or was otherwise identified as described above. Fields 104 and 108 may be filled by the casino to personalize the message, or other message text or graphics can be provided. Display screen 102 also includes a touchscreen button 110, or other facility, for the player to indicate that he or she is not the currently identified player. Touching the touchscreen button 110 causes the gaming device 10 to disassociate the presently associated player, currently Elizabeth, from the present gaming session. Then, the new player (not Elizabeth) can identify himself or herself to the gaming device 10, by, for instance, inserting their own player card, or call an attendant over for help.

FIG. 6B illustrates a scenario where the player, here Mike, has identified himself to the gaming device 10 but has not yet started playing. A display screen 120 identifies the player in the field 106, and includes the other fields 104, 108 and the button 110 described above. Because Mike has not yet started playing, display screen 120 includes a message that encourages Mike to begin playing. In this example, a countdown box 122 is displayed, which informs the player that he or she has 30 seconds to insert credit to the machine and begin playing. The countdown box 122 will count down, for instance in real time, until it reaches zero. If Mike begins playing before the countdown box 122 reaches zero, the display screen 120 may change to the display screen 102 described in FIG. 6A above, and gameplay is properly attributed to Mike. If instead Mike does not begin playing before the countdown box 122 reaches zero, Mike's player identification is disassociated with gaming device 10. In other words, the gaming device 10 reverts back to an un-identified player, as described with reference to FIG. 6C below. An extend button 124 may be presented to the player to extend the time to begin a gameplay session and still be associated with the gaming session. For example, if Mike is taking a phone call, but still wishes to play the gaming device 10 on which he is already identified, Mike can press the extend button 124 to extend the time shown in the countdown box 122.

FIG. 6C illustrates another display screen 130, in this case to communicate to a player that the player is unidentified. The display screen 130 includes the same fields 104 and 108 as the display screens 102 and 120, described above. Because the player is unidentified, field 106 includes a generic name, such as “player.” Two touchscreen buttons 132, 134 appear on the display screen 130. The button 132, when pressed, allows the player to sign up for a player account directly on the gaming device 10. If the player touches the button 132, a sign-up screen is displayed on the gaming device 10 where the player can sign up for a new account. Instead, if the player does not feel comfortable signing up for a player account unassisted, the player can touch the button 134 to call a casino employee to come assist the player to sign up for an account.

Any of the display screens 102, 120, 130 may be different colors or be sequenced with different audio signals through the speaker 26 (FIG. 1) depending on their status. For example, with an identified player as with the display screen 102, the screen 102 may have a green background color. The unidentified display screen 130 may instead be red. The countdown display screen 120 may begin green, or perhaps a lighter shade of green than the screen 102, and trend toward red as the countdown box 122 nears zero. Audio signals may accompany any or all of these screens through the speaker 26 of the gaming device 10. For example, an audio “beep” may sound, once each second, when the countdown box 122 is under 10 seconds.

Embodiments of the invention can help casinos sign members up for player accounts. In such a system, if a casino employee notices a player playing at a game and, by inspecting the audio or visual display determines that the player is not identified, the employee can approach the player with an identification application. Once the player is signed up and given a player account, all of the gameplay, even that gameplay that was performed before the player had a player account can be attributed to the player.

Using embodiments of the invention, gameplay data is temporarily stored for a period of time, even if no player account is associated with the gameplay before the gameplay begins. For instance, If Player B initiates gameplay by inserting $200 in cash into the machine (800 credits at a quarter machine), and plays down to 50 credits before Player B realizes that he forgot to enter his player tracking card, gameplay data that was stored beginning when the credit balance went positive can be attributed to Player B when he inserts his player tracking card or is otherwise identified.

Some embodiments of the invention have been described above, and in addition, some specific details are shown for purposes of illustrating the inventive principles. However, numerous other arrangements may be devised in accordance with the inventive principles of this patent disclosure. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims. Further, well known processes have not been described in detail in order not to obscure the invention. Thus, the inventive principles are not limited to the specific details disclosed herein.

What is claimed is:

1. A method comprising:
beginning a session of gameplay on a game;
learning an identity of a player performing the gameplay after the session began; and
attributing gameplay session credits for the entire session of gameplay to the identified player.

2. A method according to claim 1, further comprising concluding the gameplay session when credits on the game equal zero.

3. A method according to claim 1, further comprising concluding the gameplay session when credits on the game equal zero for longer than a pre-defined time period.

4. A method according to claim 1, further comprising concluding the gameplay session when credits on the game are below a minimum denomination of the game.

5. A method according to claim 1, further comprising concluding the gameplay session when credits on the game are below a minimum denomination of the game for longer than a predetermined time period.

6. A method according to claim 1 in which beginning a gameplay session comprises entering credits onto the game.

7. A method according to claim 6 in which entering credits onto the game comprises depositing currency into the game.

8. A method according to claim 6 in which entering credits onto the game comprises transferring value to the game from an account of the identified player.

9. A method according to claim 6 in which entering credits onto the game comprises scanning a ticket.

10. A method according to claim 1 in which learning the identity of a player comprises reading a player identification device.

11. A method according to claim 10 in which reading a player identification device comprises reading an RFID device.

12. A method according to claim 10 in which reading a player identification device comprises sensing a physical action of the player.

13. A method according to claim 10 in which the player identification device is a keypad.

14. A method according to claim 10 in which the player identification device is a touchscreen.

15. A method according to claim 10 in which reading a player identification device comprises reading biometric data.

16. A method, comprising:
beginning recording gameplay data of a game at a beginning of a gaming session;
concluding recording gameplay data at the conclusion of a gaming session;
learning the identity of a player in a player identification transaction that has a duration shorter than a duration of the gaming session; and
crediting all of the recorded gameplay data to the player identified in the player identification transaction.

17. A method according to claim 16 in which the conclusion of a gaming session occurs when a number of credits equals zero.

18. A method according to claim 16 in which the conclusion of a gaming session occurs only after a number of credits on the game equals zero longer than a pre-defined time period.

19. A method according to claim 16 in which the gaming session begins when money is deposited into the game.

20. A method according to claim 16 in which the gaming session begins when a player identifies himself or herself.

21. A method according to claim 16 in which the gaming session begins when value from an account associated with a player is transferred to the game.

22. A method, comprising:
attributing to a player gameplay credit accumulated during a time period when no player was identified.

23. A method according to claim 22 in which attributing gameplay credit comprises attributing credit accumulated during a gameplay session.

24. A method according to claim 23 in which the gameplay session begins when playing credit is entered on a game.

25. A method according to claim 23 in which the gameplay session ends when the gameplaying credit reaches zero.

26. A method according to claim 22 in which the gameplay session ends when the game credit remains at zero for longer than a fixed duration.

27. A method for attributing gameplay credit, comprising:
identifying a player before a gameplay session begins in a player identifying transaction;
after the player identifying transaction has ended, beginning the gameplay session; and
attributing gameplay credit accumulated during the gameplay session to the identified player.

28. A method according to claim 27, in which ending the player identifying transaction comprises removing a player card from a gaming device.

29. A method according to claim 27 in which ending the player identifying transaction comprises indexing a code derived from an RFID device.

30. A method according to claim 27, further comprising ending the gaming session when, on the game on which the gameplay session occurred, there are less credits than a minimum denomination of the game.

31. A method according to claim 27, further comprising ending the gaming session when there are zero credits on a game for longer than a first duration.

32. A method according to claim 27, further comprising:
when credits on a game on which the gameplay session occurred are less than a minimum denomination of the game, starting an interval timer;
stopping the interval timer when a second gameplay session begins;
comparing an interval duration to a predetermined time interval; and
attributing gameplay credit for the second gameplay session to the identified player if the interval duration is shorter than the predetermined time interval.

33. A method, comprising:
recognizing an identification instrument proximate to a gaming device;
determining a player identity from the identification instrument;
attributing gameplay credit on the gaming device to the identified player when the identification instrument is no longer proximate the gaming device.

34. A method according to claim 33 in which attributing gameplay credit comprises attributing credit accumulated during a gameplay session.

35. A method according to claim 33 in which the gameplay session begins when playing credit is entered on a game.

36. A method according to claim 33 in which the gameplay session ends when the gameplay credit reaches a level below a minimum wagering denomination of the gaming device.

37. A method according to claim 33 in which the gameplay session ends when the gameplay credit remains at a level below a minimum wagering denomination of the gaming device for longer than a predetermined duration.
